(19) United States
(12) Patent Application Publication
(10) Pub. No.: US 2016/0165587 A1
(43) Pub. Date: Jun. 9, 2016

(54) UPLINK THROUGHPUT ENHANCEMENT VIA MINIMUM POWER CONSTRAINED USER DEVICES

(71) Applicant: QUALCOMM Incorporated, San Diego, CA (US)

(72) Inventors: James Francis DURCAN, Newtown, PA (US); Yeon Kyoon JEONG, Lafayette, CO (US); Elangovan KRISHNA MURTHY, Bridgewater, NJ (US)

(21) Appl. No.: 14/560,940

(22) Filed: Dec. 4, 2014

(51) Int. Cl. H04W 72/04; H04W 52/18; H04W 52/02; H04W 24/02; H04W 24/08

(52) U.S. Cl. CPC H04W 72/0413; H04W 24/02; H04W 24/08; H04W 52/0209; H04W 52/18; H04W 88/02

(57) ABSTRACT

Systems and methods are disclosed for enhancing uplink throughput at a small cell base station. The small cell base station may monitor a power level associated with one or more user device (UD) transmissions from a UD, determine that the UD is at a UD transmit power floor based on the monitored power level, and adjust a data rate assigned to the UD based on the determination that the UD is at the UD transmit power floor.

### INTRODUCTION

Aspects of this disclosure relate generally to telecommunications, and more particularly to uplink scheduling and the like.

In cellular networks, “macro cell” base stations provide connectivity and coverage to a large number of users over a certain geographical area. To improve indoor or other specific geographic coverage (such as, for example, in residential homes and office buildings) additional “small cell”, typically low-power base stations have recently begun to be deployed to supplement conventional macro networks.

Regardless of the size of the base station (BS), there is a need to manage interference levels such that the total throughput of the wireless communication system is maximized. New solutions are needed for recognizing a user device (UD) that is operating at its transmit power floor (i.e., a power level below which the UD is incapable of transmitting) and managing it so as to maximize or otherwise optimize a cell's total uplink throughput.

### SUMMARY

In one aspect, the present disclosure provides a method for enhancing uplink throughput at a small cell BS. The method may comprise, for example: monitoring a power level associated with one or more UD transmissions from a UD, determining that the UD is at a UD transmit power floor based on the monitored power level, and adjusting a data rate assigned to the UD based on the determination that the UD is at the UD transmit power floor.

In another aspect, the present disclosure provides an apparatus for enhancing uplink throughput at a small cell BS. The apparatus may comprise a memory and a processor. The processor may, for example: monitor a power level associated with one or more UD transmissions from a UD, determine that the UD is at a UD transmit power floor based on the monitored power level, and adjust a data rate assigned to the UD based on the determination that the UD is at the UD transmit power floor.

In another aspect, the present disclosure provides another apparatus for enhancing uplink throughput at a small cell BS. The apparatus may comprise, for example: means for monitoring a power level associated with one or more UD transmissions from a UD, means for determining that the UD is at a UD transmit power floor based on the monitored power level, and means for adjusting a data rate assigned to the UD based on the determination that the UD is at the UD transmit power floor.

In another aspect, the present disclosure provides a computer-readable medium comprising code, which, when executed by a processor, causes the processor to perform operations for enhancing uplink throughput at a small cell BS. The computer-readable medium may comprise, for example: code for monitoring a power level associated with one or more UD transmissions from a UD, code for determining that the UD is at a UD transmit power floor based on the monitored power level and code for adjusting a data rate assigned to the UD based on the determination that the UD is at the UD transmit power floor.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example mixed-deployment wireless communication system including macro cell BSs and small cell BSs.

FIG. 2 is a flow diagram generally illustrating a method of enhancing throughput on the uplink.

FIG. 3 is a signaling flow diagram generally illustrating a particular implementation of the method of FIG. 2 utilizing received power levels of UD transmissions.

FIG. 4 is a flow diagram generally illustrating a particular method of implementing the method of FIG. 2 utilizing received power levels of UD transmissions.

FIG. 5 is a signaling flow diagram generally illustrating a particular implementation of the method of FIG. 2 utilizing headroom indicators associated with UD transmissions.

FIG. 6 is a flow diagram generally illustrating a particular method of implementing the method of FIG. 2 utilizing headroom indicators associated with UD transmissions.

FIG. 7 is a simplified block diagram of several sample aspects of components that may be employed in communication nodes and enabled to support communication as taught herein.

FIG. 8 is a simplified block diagram of several sample aspects of apparatuses enabled to support communication as taught herein.

FIG. 9 illustrates an example communication system environment in which the teachings and structures herein may be may be incorporated.

### DETAILED DESCRIPTION

The present disclosure generally relates to enhancement of uplink throughput for a cell containing one or more user devices (UDs) that are operating at their transmit power floor. To optimize throughput, a base station (BS) takes into account the constraints under which the UD operates. In particular, the BS determines when a UD is operating at its transmit power floor, and adjusts the data rate assigned to the UD so as to optimize throughput.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Third Generation Partnership Project (3GPP), 3GPP Long Term Evolution (LTE), Universal Mobile Telecommunications System (UMTS), Ultra Mobile Broadband (UMB), Evolution Data Optimized (EV-DO), Institute of Electrical and Electronics Engineers (IEEE), etc.

In cellular networks, “macro cell” base stations provide connectivity and coverage to a large number of users over a certain geographical area. A macro network deployment is carefully planned, designed, and implemented to offer good coverage over the geographical region. Even such careful planning, however, cannot fully accommodate channel characteristics such as fading, multipath, shadowing, etc., especially in indoor environments. Indoor users therefore often face coverage issues (e.g., call outages and quality degradation) resulting in poor user experience.

To improve indoor or other specific geographic coverage, such as for residential homes and office buildings, additional “small cell”, typically low-power base stations have recently begun to be deployed to supplement conventional macro networks. Small cell base stations may also provide incremental capacity growth, richer user experience, and so on.

Regardless of the size of the BS, there is a need to manage interference levels such that the total throughput of the wireless communication system is maximized. In UMTS, for example, the interference caused by UDs engaged in uplink transmissions can be quantified in terms of rise over thermal (RoT). The RoT in a cell is defined as a ratio of total received power to thermal noise power. The total received power includes the power of all received signals, including intended transmissions, interfering transmissions, and other noise. The BS is required to keep the total RoT for the cell (RoT_{CELL}) below a certain maximum value. RoT_{CELL} is equal to the sum of the RoT caused by each UD operating in the cell. The RoT attributable to any given UD correlates to that UD's assigned transmission power level. Therefore, according to one conventional technique, the BS manages RoT_{CELL} by exerting control over the individual transmission power levels of each UD in the cell.

In order to distribute transmission resources to each UD in the cell while managing RoT_{CELL}, the BS will occasionally, (e.g., periodically) perform link adaptation. In a link adaptation process, a BS may target, for example, a specific probability of error for each uplink transmission. An individual user device UDᵢ that transmits at a high transmission power level, such that the power received at the BS is sufficiently above the noise level, will transmit with a high data throughput or low probability of error; however, UDᵢ's transmission will also cause interference with the uplink transmissions of other UDs in the cell. Therefore, the BS optimizes uplink throughput by controlling the transmission power level of UDᵢ such that it is high enough to transmit with a tolerable error probability, but not so high that it causes undue interference with other uplinks. This technique is known as transmission power control (TPC).

Using a TPC technique, an individual user device UDᵢ that is experiencing good channel conditions will tend to have its transmission power levels reduced until the error probability rises to the target error probability. However, if TPC techniques fail to result in reduced transmission levels, then the interference caused by UDᵢ may increase such that it limits access to uplink resources for other UDs in the cell. In other words, a UDᵢ that transmits with unnecessarily high power on the uplink will consume an unnecessarily large amount of the RoT_{CELL} budget for the cell.

As noted above, UMTS BSs are often designed to maintain RoT_{CELL} below a certain maximum value. If UDᵢ transmits at an unnecessarily high power level and does not follow instructions to lower its transmission power level, then one of two things may occur. In a first scenario, the BS is forced to increase the transmission power levels of the other UDs in the cell. In this case, overall uplink throughput is maintained, but RoT_{CELL} rises. In a second scenario, RoT_{CELL} is already at its maximum, and the BS is forced to reapportion the RoT_{CELL} budget among the various UDs. Since UDᵢ is consuming a disproportionate amount of the RoT_{CELL} budget (and not following instructions to reduce its transmission power level), the BS may be compelled to reduce the respective transmission power level of the other UDs in the cell. When the respective transmission power levels are reduced, the data rates may also be reduced in order to reach the target error probability. In this scenario, overall uplink throughput diminishes due to the disproportionately high transmission power level of UDᵢ.

This problem is increasingly evident in the context of a small cell environment. In a small cell environment, the distance between a BS and an individual user device UDᵢ can be vanishingly small. Proximity between BS and UDᵢ will tend to correlate with better channel conditions, which suggests that UDᵢ's transmission power level should be reduced as BS and UDᵢ become more proximate. However, a UD is often limited to a characteristic range of transmission power levels. If the BS controls UDᵢ to transmit at lower and lower power levels, the possibility arises that UDᵢ will reach a transmit power floor, i.e., a power level below which the UD is incapable of transmitting. The exact level of a given UD's transmit power floor may be determined by hardware or programming limitations that are unknown to the BS.

If UDᵢ reaches its transmit power floor and continues to transmit at an excessive power level, the BS may attempt to limit RoT_{CELL} by lowering the transmission power levels of other UDs in the cell. This simple approach may not result in maximized overall uplink throughput. Therefore, new solutions are needed for recognizing a UD which is operating at its transmit power floor and managing it so as to maximize or otherwise optimize a cell's total uplink throughput.

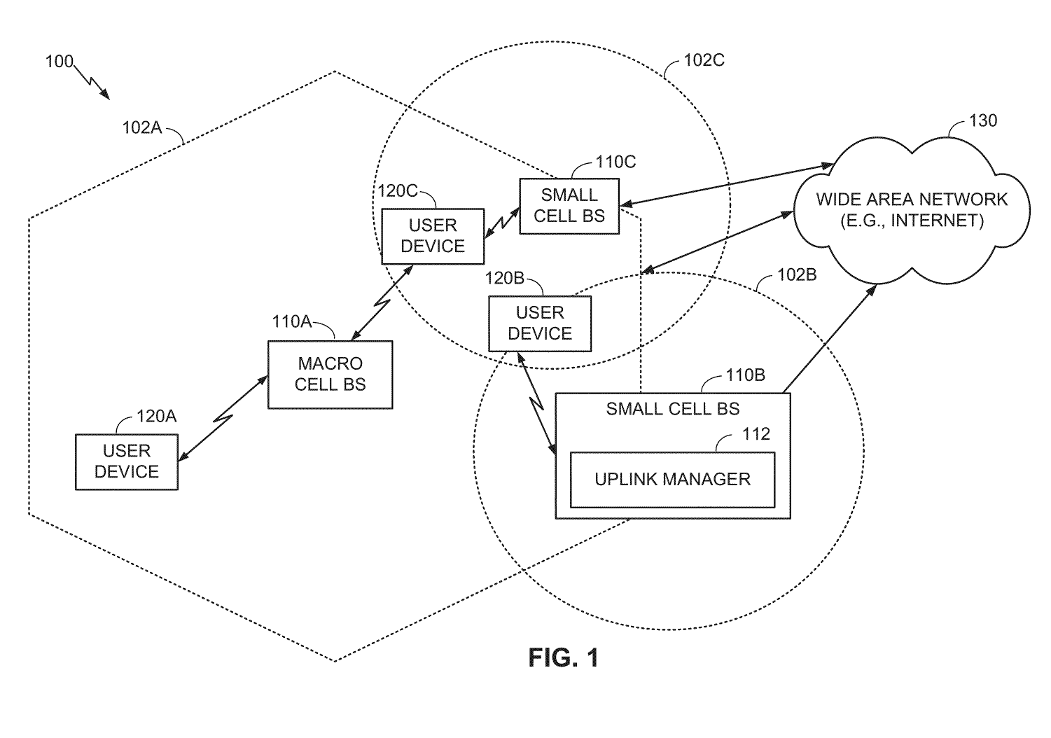

FIG. 1 illustrates an example mixed-deployment wireless communication system, in which small cell BSs are deployed in conjunction with and to supplement the coverage of macro cell BSs. As used herein, small cells generally refer to a class of low-powered BSs that may include or be otherwise referred to as femto cells, pico cells, micro cells, etc. As noted above, they may be deployed to provide improved signaling, incremental capacity growth, richer user experience, and so on.

The illustrated wireless communication system 100 is a multiple-access system that is divided into a plurality of cells 102 and configured to support communication for a number of users. Communication coverage in each of the cells 102 is provided by a corresponding BS 110, which interacts with one or more UDs 120 via DownLink (DL) and/or UpLink (UL) connections. In general, the DL corresponds to communication from a BS to a UD, while the UL corresponds to communication from a UD to a BS.

As will be described in more detail below, these different entities may be variously configured in accordance with the teachings herein to provide or otherwise support the uplink throughput enhancement discussed briefly above. For example, one or more of the small cell BSs 110 may include an uplink management module 112.

As used herein, the terms “user device” and “base station” are not intended to be specific or otherwise limited to any particular Radio Access Technology (RAT), unless otherwise noted. In general, such UDs may be any wireless communication device (e.g., a mobile phone, router, personal computer, server, etc.) used by a user to communicate over a communications network, and may be alternatively referred to in different RAT environments as an Access Terminal (AT), a Mobile Station (MS), a Subscriber Station (STA), a User Equipment (UE), etc. Similarly, a BS may operate according to one of several RATs in communication with UDs depending on the network in which it is deployed, and may be alternatively referred to as an Access Point (AP), a Network Node, a NodeB, an evolved NodeB (eNB), etc. In addition, in some systems a BS may provide purely edge node signaling functions while in other systems it may provide additional control and/or network management functions.

Returning to FIG. 1, the different BSs 110 include an example macro cell BS 110A and two example small cell BSs 110B, 110C. The macro cell BS 110A is configured to provide communication coverage within a macro cell coverage area 102A, which may cover a few blocks within a neighborhood or several square miles in a rural environment. Meanwhile, the small cell BSs 110B, 110C are configured to provide communication coverage within respective small cell coverage areas 102B, 102C, with varying degrees of overlap existing among the different coverage areas. In some systems, each cell may be further divided into one or more sectors (not shown).

Turning to the illustrated connections in more detail, the UD 120A may transmit and receive messages via a wireless link with the macro cell BS 110A, the message including information related to various types of communication (e.g., voice, data, multimedia services, associated control signaling, etc.). The UD 120B may similarly communicate with the small cell BS 110B via another wireless link, and the UD 120C may similarly communicate with the small cell BS 110C via another wireless link. In addition, in some scenarios, the UD 120C, for example, may also communicate with the macro cell BS 110A via a separate wireless link in addition to the wireless link it maintains with the small cell BS 110C.

As is further illustrated in FIG. 1, the macro cell BS 110A may communicate with a corresponding wide area or external network 130, via a wired link or via a wireless link, while the small cell BSs 110B, 110C may also similarly communicate with the network 130, via their own wired or wireless links. For example, the small cell BSs 110B, 110C may communicate with the network 130 by way of an Internet Protocol (IP) connection, such as via a Digital Subscriber Line (DSL, e.g., including Asymmetric DSL (ADSL), High Data Rate DSL (HDSL), Very High Speed DSL (VDSL), etc.), a TV cable carrying IP traffic, a Broadband over Power Line (BPL) connection, an Optical Fiber (OF) cable, a satellite link, or some other link.

The network 130 may comprise any type of electronically connected group of computers and/or devices, including, for example, Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 130 includes network variations such as the public Internet, a private network within the Internet, a secure network within the Internet, a private network, a public network, a value-added network, an intranet, and the like. In certain systems, the network 130 may also comprise a Virtual Private Network (VPN).

Accordingly, it will be appreciated that the macro cell BS 110A and/or either or both of the small cell BSs 110B, 110C may be connected to the network 130 using any of a multitude of devices or methods. These connections may be referred to as the “backbone” or the “backhaul” of the network, and may in some implementations be used to manage and coordinate communications between the macro cell BS 110A, the small cell BS 110B, and/or the small cell BS 110C. In this way, as a UD moves through such a mixed communication network environment that provides both macro cell and small cell coverage, the UD may be served in certain locations by macro cell BSs, at other locations by small cell BSs, and, in some scenarios, by both macro cell and small cell BSs.

For their wireless air interfaces, each BS 110 may operate according to one of several RATs depending on the network in which it is deployed. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement a RAT such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2). These documents are publicly available.

As discussed above, conventional BS designs fail to recognize when a UD is operating at a transmit power floor. When a UD is operating at its transmit power floor, it will tend to ignore TPC commands instructing the UD to reduce its transmission power level. As a result, a UD operating at its transmit power floor can cause excessive interference, consuming a disproportionate amount of the cell's RoT budget.

As small cell BSs in particular proliferate, this scenario may become increasingly frequent. Because the distance between a small cell BS and a UD can be very small, the appropriate transmission power level for the UD may become very low. UDs that are constrained by a transmit power floor will tend to ignore TPC commands, and conventional BSs are not equipped to recognize or manage a UD operating at its transmit power floor.

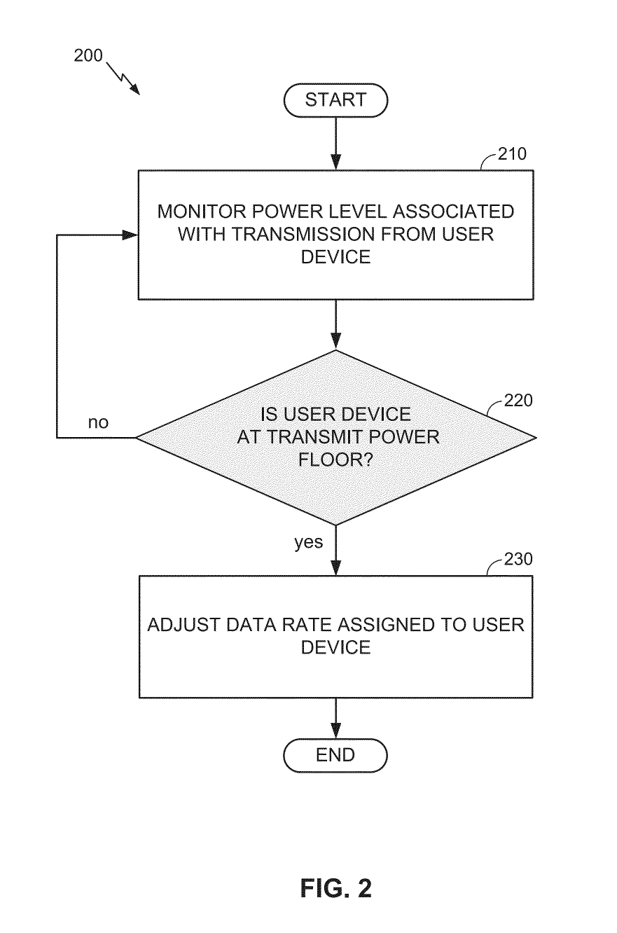

As an enhancement to the conventional approach, FIG. 2 is a flow diagram that generally illustrates an example method of enhancing throughput on the uplink. The method 200 may be performed, for example, by a BS (e.g., the small cell BS 110C illustrated in FIG. 1).

At 210, a transmission power level associated with at least one transmission from a UD is monitored. Power level monitoring may utilize any information that indicates or correlates with a transmission power level, whether directly or indirectly. For example, power level monitoring may utilize any combination of one or more of a received signal strength of the transmission, a power headroom indicator, a prior transmission power level, and/or an instructed transmission power level (e.g., a TPC command).

At 220, it is determined whether the UD is at a UD transmit power floor based on the power levels monitored at 210. A transmit power floor generally corresponds to the lower limit of the range of transmission power levels to which a given UD is constrained. UDs are limited to a characteristic range of transmission power levels, which may vary among different UDs, and may also vary for any given UD across a range of circumstances. At the upper bounds of the range (a transmit power ceiling), the UD may be constrained for any number of reasons, including, for example, hardware restrictions, power conservation concerns, or regulatory limits. With regards to the lower bounds of the range, the hardware or programming associated with a UD may prevent transmissions that are below the UD's transmit power floor. If at 220 the UD is determined to be at a transmit power floor, the method 200 proceeds to 230. Otherwise, the method 200 returns to 210, and the monitoring of transmission power levels continues.

At 230, the data rate assigned to the UD is adjusted based on the determination at 220 that the UD is at a transmit power floor. The adjustment may comprise an increase or decrease in the data rate. Alternatively, maintenance of a prior data rate can constitute an adjustment. Generally, the adjustment targets increased uplink throughput while recognizing the transmission power level constraints, particularly transmit power floor, under which the UDs operate.

In one possible implementation, the method of FIG. 2 is performed at a UMTS small cell base station. In this implementation, adjusting the data rate may comprise transmitting a scheduling grant to the UD.

These techniques may provide various advantages over conventional BS designs. For example, as noted above, in some conventional BS designs, the BS may simply fail to recognize that a UD is ignoring TPC commands to reduce transmission power levels. The BS will therefore continue to maintain the assigned data rate while transmitting a continuous series of futile TPC commands In other words, the BS may perceive that the optimal control scheme is to simply lower the transmission power level of the UD while failing to recognize that such a control scheme cannot be implemented due to transmit power floor constraints on the UD. A BS operating in accordance with the techniques provided herein, by contrast, is capable of recognizing at 220 that the UD has transmit power floor constraints. In a situation where a UD is operating at a transmit power floor, the BS recognizes that the optimal control scheme does not include a continuous series of unheeded TPC commands. Instead, the BS may adjust data rates as in 230 by, for example, increasing data rates so that the duration over which the interference must be tolerated can be reduced.

As another example, in other conventional BS designs, the BS may recognize that TPC has failed with respect to a UD that is causing high levels of interference, or at least recognize that present levels of interference are unsustainable. The BS may then reduce the data rate assigned to the UD until the error probability associated with the UD is at the target error probability. Additionally or alternatively, the BS may reduce the transmission power levels of the other UDs operating in the cell. A BS operating in accordance with the techniques provided herein, by contrast, is capable of recognizing that the UD has transmit power floor constraints. In a situation where a UD is operating at a transmit power floor, the BS recognizes that the optimal control scheme does not include reducing the data rate of the UD until the total RoT is at acceptable levels, or lowering the transmission power levels of all the other UDs operating in the cell until the total RoT is at acceptable levels. Instead, the BS adjusts data rates as in 230 by, for example, increasing data rates so that the duration over which the interference must be tolerated can be reduced. Alternatively, under some circumstances, the BS may be able to improve on conventional control schemes by simply maintaining the assigned data rate, or by decreasing it less than it would be decreased under the conventional control scheme.

In one possible implementation of the method shown in FIG. 2, a power level associated with transmissions from a user device (such as UD 120 of FIG. 1) is monitored at 210 by logging a set of TPC commands associated with the UD 120. The set of logged TPC commands may include a predetermined number of the most recent TPC commands, or alternatively, each TPC command that is sent over a predetermined duration of time. If a large percentage of the set of logged TPC commands request that UD 120 reduce power levels, then this may indicate that the UD 120 is operating at its transmit power floor. For example, if the percentage of the set of logged TPC commands that are associated with power level reduction exceeds a predetermined threshold percentage, it is determined at 220 that the UD 120 is operating at its transmit power floor. As a result, the data rate assigned to UD 120 is adjusted at 230.

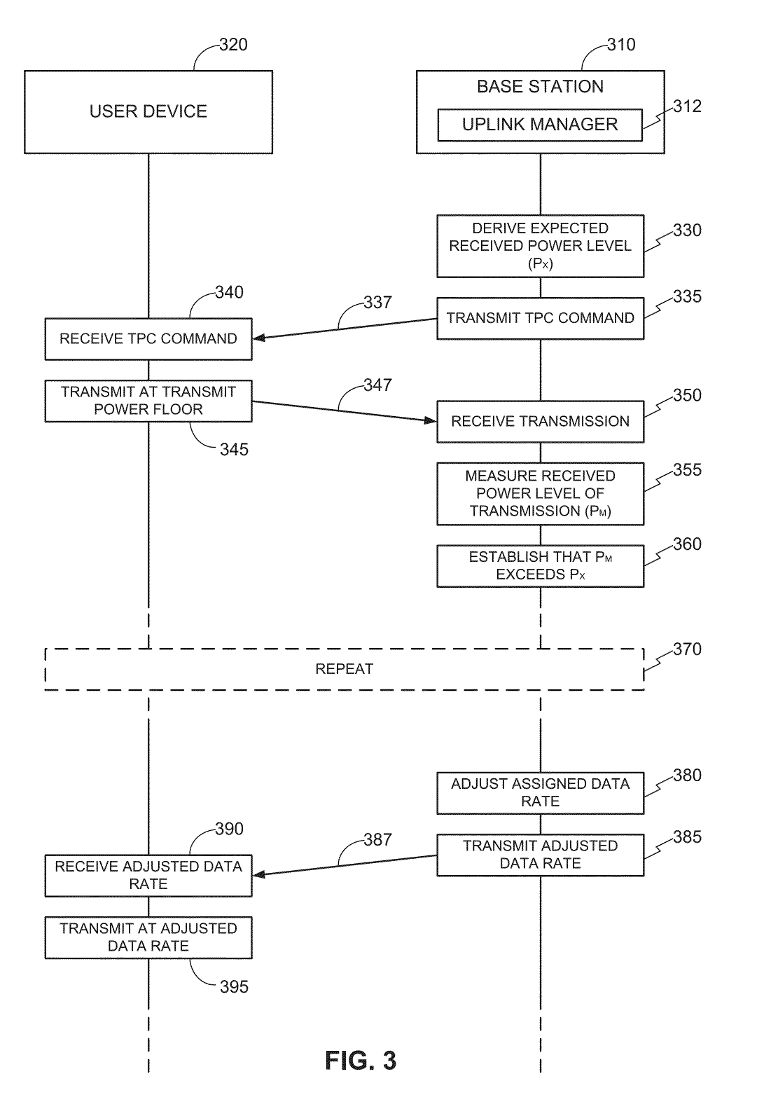

FIG. 3 illustrates a flow diagram of another particular implementation of the method shown in FIG. 2. In FIG. 3, a BS 310 having an uplink manager 312 communicates with a UD 320. The BS 310, uplink manager 312, and UD 320 may be analogous to the BS 110, uplink manager 112, and UD 120 of FIG. 1.

At 330, the BS 310 derives an expected received power level (P_{X}) for a transmission received from UD 320. The expected received power level P_{X} may include an expected measured power level, i.e., the power level that the BS 310 expects to measure upon receiving the transmission from UD 320. At 335, the BS 310 transmits a TPC command 337 to the UD 320. It will be understood that although FIG. 3 shows a sequence in which 330 precedes 335, they may occur simultaneously or in the opposite order.

At 340, the UD 320 receives the TPC command 337. In the scenario depicted in FIG. 3, the transmission power level instructed by the BS 310 is lower than the transmit power floor of the UD 320. As a result, UD 320 cannot reduce its transmission power level as instructed. Accordingly, UD 320 transmits 347 at the lowest transmission power level that it is capable of transmitting at, i.e., the transmit power floor.

At 350, BS 310 receives the transmission 347. At 355, BS 310 measures the received power level of transmission 347 to generate a value for measured power level (P_{M}). At 360, BS 310 establishes that P_{M} exceeds P_{X} by a significant margin. For example, BS 310 may establish that the difference between P_{M} and P_{X} exceeds a threshold, i.e., P_{M}−P_{X}>P_{THRESHOLD}. The threshold amount may be arbitrarily determined For example, the threshold amount may be greater than a typical noise signal, thereby representing a significant difference between P_{M} and P_{X} that exceeds typical noise levels.

At 370, BS 310 repeats one or more of 330 through 360. Alternatively, one or more of 330 through 360 may be repeated multiple times, or 370 may be omitted altogether.

At 380, BS 310 adjusts the data rate assigned to the UD 320. In some scenarios, 380 is performed if it is established at 360 that P_{M} exceeds P_{X}. Alternatively, 380 is only performed if the process of FIG. 3 is repeated one or more times at 370 and it is established in all or a large fraction of the performances of 360 that P_{M} exceeds P_{X}. At 385, BS 310 transmits the adjusted data rate to the UD 320. At 390, UD 320 receives the adjusted data rate, and at 395, UD 320 transmits at the adjusted data rate. The entire process of FIG. 3 may be repeated after the data rate is adjusted so as to implement continuous monitoring and adjustment.

The expected received power level P_{X} may be derived at 330 using any appropriate formula or algorithm. In one scenario, the BS 310 may derive P_{X} in conjunction with the TPC command 337. For example, upon a marginal reduction in the transmission power level identified in the TPC command 337, the BS 310 may derive a P_{X} that is marginally reduced in relation to the most recent received power level. In another possible scenario, the BS 310 may derive P_{X} in view of an identified trend in the trajectory of previous received power levels. For example, if the UD 320 is moving toward the BS 310, the received power levels may be increasing in a predictable fashion. Other scenarios for deriving P_{X} are contemplated as well, as is any combination of the scenarios identified above.

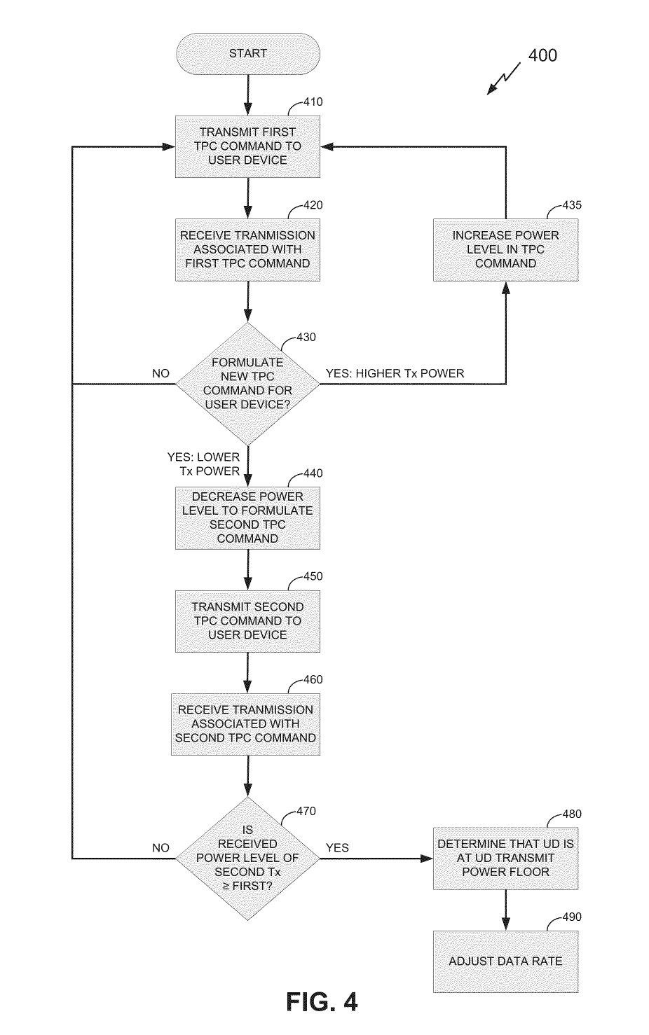

FIG. 4 illustrates another flow diagram of a particular implementation of the method shown in FIG. 2. Each block in the method 400 depicted in FIG. 4 may be performed by a base station, for example, BS 310 of FIG. 3.

At 410, a first TPC command is transmitted to a UD such as UD 120. At 420, a transmission is received from the UD 120 which is associated with the first TPC command transmitted at 410. At 430, it is determined whether a new TPC command will be formulated. For example, the determination as to whether a new TPC command will be formulated may be made on the basis of link adaptation techniques, as described above. If a determination is made to raise the transmission power level of the UD 120, then the power level indicated in the TPC is increased as shown at 435 and the process returns to 410, where a new first TPC (associated with a higher power level) is transmitted. If no change to the transmission power level of UD 110 is necessary, then the process returns to 410, where a new first TPC command is transmitted (wherein the instructed power level is maintained). Alternatively, if no change to the transmission power level of UD 110 is necessary, the process may skip 410 and wait for receipt of a new transmission as in 420.

If a determination is made to lower the transmission power level of the UD 120, then the power level indicated in the first TPC command is decreased, and the new decreased power level is used to formulate a second TPC command, as shown at 440. At 450, the second TPC command formulated at 440 is transmitted to UD 120. At 460, a transmission is received from the UD 120 that is associated with the second TPC command transmitted at 450. At 470, a determination is made as to whether the power level of the transmission received at 460 is substantially equal to or greater than the power level of the transmission received at 420. For example, a determination may be made as to whether the difference between the power level of the transmission received at 460 (P₂) and the power level of the transmission received at 420 (P₁) exceeds a threshold, i.e., P₂−P₁>P_{THRESHOLD}. The power level of a first received transmission is “substantially equal to” the power level of a second received transmission if, for example, the difference is so small as to be negligible with respect to the precision limits of the device making the determination. In another example, the power level of a first received transmission is “substantially equal to” the power level of a second received transmission if the difference is non-negligible, but small enough to be associated with random interference.

If UD 120 has not reached its transmit power floor, then the UD 120 should be capable of heeding the second TPC command transmitted at 450 and will accordingly transmit at a lower transmission power level. Therefore, if the power level of the transmission received at 460 is substantially less than the power level of the transmission received at 420, it can be established that the UD 120 has not reached its transmit power floor. In such a scenario, the process returns to 410, where a new first TPC command (equal to the second TPC command formulated at 440) is transmitted. Alternatively, the process may return to 420 or 430. If the process returns to 430, the transmission received at 460 may be used to determine whether to formulate a new TPC.

On the contrary, if UD 120 has reached its transmit power floor, then the UD 120 will not be able to transmit at a lower transmission power level (as instructed by the second TPC command transmitted at 450). Accordingly, if the power level of the transmission received at 460 is substantially equal to or greater than the power level of the transmission received at 420, the process proceeds to 480 where it is determined that the UD is at the UD's transmit power floor. At 490, the data rate of the UD is adjusted for the purpose of optimizing uplink throughput in accordance with the known constraints on the transmission power levels of the UD.

Although FIG. 4 depicts at 480 that the UD is determined to be at a transmit power floor based on a single determination at 470 that the received power level of the transmission received at 460 is substantially equal to or greater than the power level of the transmission received at 420, it will be understood that 480 may alternatively rely on multiple such determinations. For example, 480 may include a subroutine in which 450, 460, and 470 are repeated multiple times before making a final determination that the UD is at a transmit power floor. Moreover, the entire process of FIG. 4 may be repeated after the data rate is adjusted at 490 so as to implement continuous monitoring and adjustment.

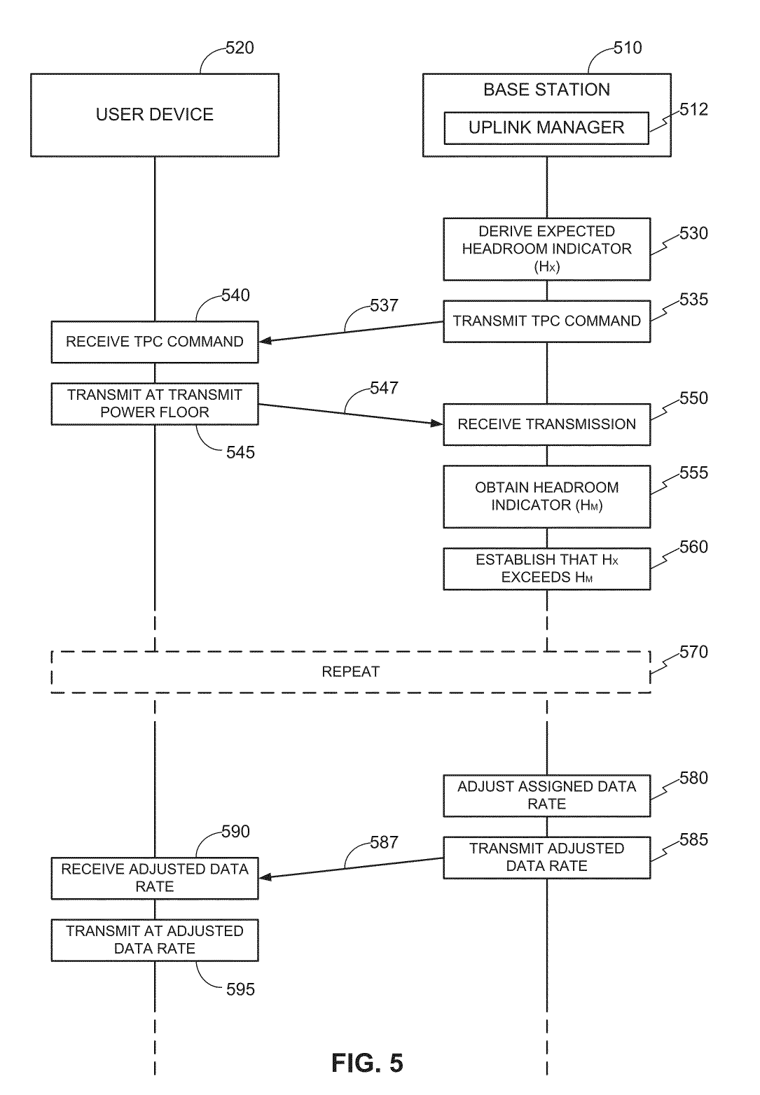

FIG. 5 illustrates a flow diagram of a particular implementation of the method shown in FIG. 2. In FIG. 5, a BS 510 having an uplink manager 512 communicates with a UD 520. The BS 510, uplink manager 512, and UD 520 may be analogous to the BS 110, uplink manager 112, and UD 120 of FIG. 1.

At 530, the BS 510 derives an expected headroom indicator (H_{X}) for a transmission received from UD 520. At 535, the BS 510 transmits a TPC command 537 to the UD 520. It will be understood that although FIG. 5 shows a sequence in which 530 precedes 535, these operations may occur simultaneously or in the opposite order.

A headroom indicator is data that relates to the marginal transmission power that is available to a UD. For example, it may be equal to the difference between the maximum transmission power level of the UD and the present transmission power level of the UD. According to some schemes, headroom is measured directly by the UD and data on the headroom, i.e., headroom indicators, are transmitted to the BS.

At 540, the UD 520 receives the TPC command. In the scenario depicted in FIG. 5, the transmission power level instructed by the BS 510 is lower than the transmit power floor of the UD 520. As a result, UD 520 cannot reduce its transmission power level as instructed. Accordingly, UD 520 transmits 547 at the lowest transmission power level that it is capable of transmitting at, i.e., the transmit power floor.

According to some schemes, a headroom indicator is encoded in the transmission 547. Alternatively, the headroom indicator is independently transmitted to the BS 520. Additionally or alternatively, a headroom indicator is encoded (or transmitted) only if the measured amount of headroom has changed, and if the BS does not receive a headroom indicator, it is implied that the amount of headroom has not changed since the last headroom indicator was received.

At 550, BS 510 receives the transmission 547. At 555, BS 510 decodes the headroom indicator (H_{M}) encoded in the transmission 547. Alternatively, if the H_{M} is independently transmitted, BS 510 simply receives it. Or, if no H_{M} is received, the BS may conclude that the amount of headroom measured at the UD has not changed, and adopts the latest H_{M} as the current H_{M}. At 560, BS 510 establishes that H_{X} exceeds H_{M} by a significant margin. For example, BS 510 may establish that the difference between H_{X} and H_{M} exceeds a threshold, i.e., H_{X}−H_{M}>H_{THRESHOLD}. The threshold amount may be arbitrarily determined For example, the threshold amount may be greater than a typical noise signal, thereby representing a significant difference between H_{X} and H_{M} that exceeds typical noise levels.

At 570, BS 510 repeats one or more of 530 through 560. Alternatively, one or more of 530 through 560 may be repeated multiple times, or 570 may be omitted altogether.

At 580, BS 510 adjusts the data rate assigned to the UD 520. In some scenarios, 580 is performed if it is established at 560 that H_{X} exceeds H_{M}. Alternatively, 580 is only performed if the process of FIG. 5 is repeated one or more times at 570 and it is established in all or a large fraction of the performances of 560 that H_{X} exceeds H_{M}. At 585, BS 510 transmits the adjusted data rate to the UD 520. At 590, UD 520 receives the adjusted data rate, and at 595, the UD 520 transmits at the adjusted data rate. The entire process of FIG. 5 may be repeated after the data rate is adjusted so as to implement continuous monitoring and adjustment.

The expected received power level H_{X} may be derived at 530 using any appropriate formula or algorithm. In one scenario, the BS 510 may derive H_{X} in conjunction with the TPC command 537. For example, upon a marginal reduction in the transmission power level identified in the TPC command 537, the BS 510 may derive an H_{X} that is marginally increased in relation to the most recent received headroom indicator. In another possible scenario, the BS 510 may derive H_{X} in view of an identified trend in the trajectory of previous received headroom indicators. For example, if the UD 520 is moving toward the BS 510, the headroom indicators may be increasing in a predictable fashion. Other scenarios for deriving H_{X} are contemplated as well, as is any combination of the scenarios identified above.

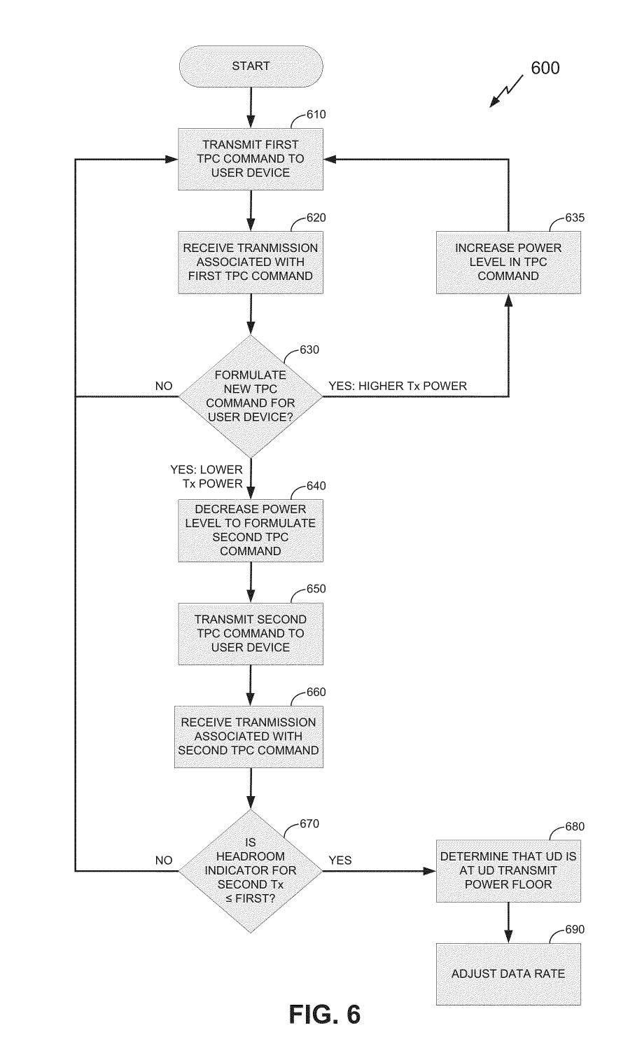

FIG. 6 illustrates another flow diagram of a particular implementation of the method shown in FIG. 2. Each block in the method 600 depicted in FIG. 6 may be performed by a base station, for example, BS 510 of FIG. 5.

At 610, a first TPC command is transmitted to a UD such as UD 120. At 620, a first transmission is received from the UD 120 that is associated with the first TPC command transmitted at 610. The transmission received at 620 may be associated with a headroom indicator. At 630, it is determined whether a new TPC command will be formulated. For example, the determination as to whether a new TPC command will be formulated may be made on the basis of link adaptation techniques, as described above. If a determination is made to raise the transmission power level of the UD 120, then the power level indicated in the TPC is increased as shown at 635 and the process returns to 610, where a new first TPC (associated with a higher power level) is transmitted. If no change to the transmission power level of UD 110 is necessary, then the process simply returns to 610, where a new first TPC command is transmitted (wherein the instructed power level is simply maintained). Alternatively, if no change to the transmission power level of UD 110 is necessary, the process may skip 610 and simply wait for receipt of a new transmission as in 620.

If a determination is made to lower the transmission power level of the UD 120, then the power level indicated in the first TPC command is decreased, and the new decreased power level is used to formulate a second TPC command, as shown at 640. At 650, the second TPC command formulated at 640 is transmitted to UD 120. At 660, a second transmission is received from the UD 120 which is associated with the second TPC command transmitted at 650. At 670, a determination is made as to whether a second headroom indicator associated with the second transmission received at 660 (H₂) is substantially equal to or less than the first headroom indicator associated with the first transmission received at 620 (H₁). For example, a determination may be made as to whether the difference between H₁ and H₂ exceeds a threshold, i.e., H₁−H₂>H_{THRESHOLD}.

If UD 120 has not reached its transmit power floor, then the UD 120 should be capable of heeding the second TPC command transmitted at 650 and will accordingly transmit at a lower transmission power level. If the transmission power level decreases, then the amount of headroom should increase, assuming that the maximum transmission power level has not changed. Therefore, if the headroom indicator associated with the transmission received at 660 (H₂) is substantially greater than the headroom indicator associated with the transmission received at 620 (H₁), it can be established that the UD 120 has not reached its transmit power floor. In such a scenario, the process returns to 610, where a new first TPC command (equal to the second TPC command formulated at 640) is transmitted. Alternatively, the process may return to 620 or 630. If the process returns to 630, the transmission received at 660 may be used to determine whether to formulate a new TPC.

On the contrary, if UD 120 has reached its transmit power floor, then the UD 120 will not be able to transmit at a lower transmission power level (as instructed by the second TPC command transmitted at 650). Therefore, the amount of headroom will not increase. Accordingly, if the headroom indicator associated with the transmission received at 660 (H₂) is substantially equal to or less than the headroom indicator associated with the transmission received at 620 (H₁), the process proceeds to 680 where it is determined that the UD is at the UD's transmit power floor. At 690, the data rate of the UD is adjusted for the purpose of optimizing uplink throughput in accordance with the known constraints on the transmission power levels of the UD.

Although FIG. 6 depicts at 680 that the UD is determined to be at a transmit power floor based on a single determination at 670 that H₂ is substantially equal to or less than H₁, it will be understood that 680 may alternatively rely on multiple such determinations. For example, 680 may include a subroutine in which 650, 660, and 670 are repeated multiple times before making a final determination that the UD is at a transmit power floor. Moreover, the entire process of FIG. 6 may be repeated after the data rate is adjusted at 490 so as to implement continuous monitoring and adjustment.

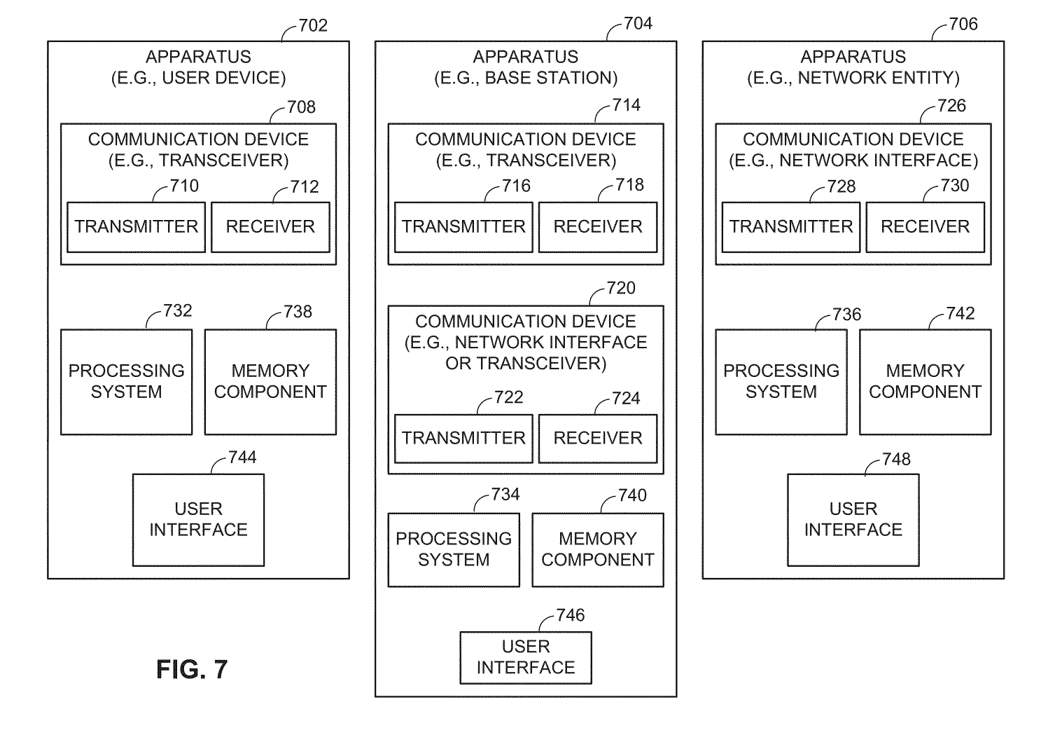

FIG. 7 illustrates several sample components (represented by corresponding blocks) that may be incorporated into an apparatus 702, an apparatus 704, and an apparatus 706 (corresponding to, for example, a UD, a BS, and a network entity, respectively) to support the uplink management operations as taught herein. It will be appreciated that these components may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 702 and the apparatus 704 each include at least one wireless communication device (represented by the communication devices 708 and 714 (and the communication device 720 if the apparatus 704 is a relay)) for communicating with other nodes via at least one designated RAT. Each communication device 708 includes at least one transmitter (represented by the transmitter 710) for transmitting and encoding signals (e.g., messages, indications, information, and so on) and at least one receiver (represented by the receiver 712) for receiving and decoding signals (e.g., messages, indications, information, pilots, and so on). Similarly, each communication device 714 includes at least one transmitter (represented by the transmitter 716) for transmitting signals (e.g., messages, indications, information, pilots, and so on) and at least one receiver (represented by the receiver 718) for receiving signals (e.g., messages, indications, information, and so on). If the apparatus 704 is a relay station, each communication device 720 may include at least one transmitter (represented by the transmitter 722) for transmitting signals (e.g., messages, indications, information, pilots, and so on) and at least one receiver (represented by the receiver 724) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. A wireless communication device (e.g., one of multiple wireless communication devices) of the apparatus 704 may also comprise a Network Listen Module (NLM) or the like for performing various measurements.

The apparatus 706 (and the apparatus 704 if it is not a relay station) includes at least one communication device (represented by the communication device 726 and, optionally, 720) for communicating with other nodes. For example, the communication device 726 may comprise a network interface that is configured to communicate with one or more network entities via a wire-based or wireless backhaul. In some aspects, the communication device 726 may be implemented as a transceiver configured to support wire-based or wireless signal communication. This communication may involve, for example, sending and receiving: messages, parameters, or other types of information. Accordingly, in the example of FIG. 7, the communication device 726 is shown as comprising a transmitter 728 and a receiver 730. Similarly, if the apparatus 704 is not a relay station, the communication device 720 may comprise a network interface that is configured to communicate with one or more network entities via a wire-based or wireless backhaul. As with the communication device 726, the communication device 720 is shown as comprising a transmitter 722 and a receiver 724.

The apparatuses 702, 704, and 706 also include other components that may be used in conjunction with the uplink management operations as taught herein. The apparatus 702 includes a processing system 732 for providing functionality relating to, for example, UD operations to support uplink management as taught herein and for providing other processing functionality. The apparatus 704 includes a processing system 734 for providing functionality relating to, for example, BS operations to support uplink management as taught herein and for providing other processing functionality. The apparatus 706 includes a processing system 736 for providing functionality relating to, for example, network operations to support uplink management as taught herein and for providing other processing functionality. The apparatuses 702, 704, and 706 include memory components 738, 740, and 742 (e.g., each including a memory device), respectively, for maintaining information (e.g., information indicative of reserved resources, thresholds, parameters, and so on). In addition, the apparatuses 702, 704, and 706 include user interface devices 744, 746, and 748, respectively, for providing indications (e.g., audible and/or visual indications) to a user and/or for receiving user input (e.g., upon user actuation of a sensing device such a keypad, a touch screen, a microphone, and so on).

For convenience, the apparatuses 702, 704, and/or 706 are shown in FIG. 7 as including various components that may be configured according to the various examples described herein. It will be appreciated, however, that the illustrated blocks may have different functionality in different designs.

The components of FIG. 7 may be implemented in various ways. In some implementations, the components of FIG. 7 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 708, 732, 738, and 744 may be implemented by processor and memory component(s) of the apparatus 702 (e.g., by execution of appropriate code and/or by appropriate configuration of processor components). Similarly, some or all of the functionality represented by blocks 714, 720, 734, 740, and 746 may be implemented by processor and memory component(s) of the apparatus 704 (e.g., by execution of appropriate code and/or by appropriate configuration of processor components). Also, some or all of the functionality represented by blocks 726, 736, 742, and 748 may be implemented by processor and memory component(s) of the apparatus 706 (e.g., by execution of appropriate code and/or by appropriate configuration of processor components).

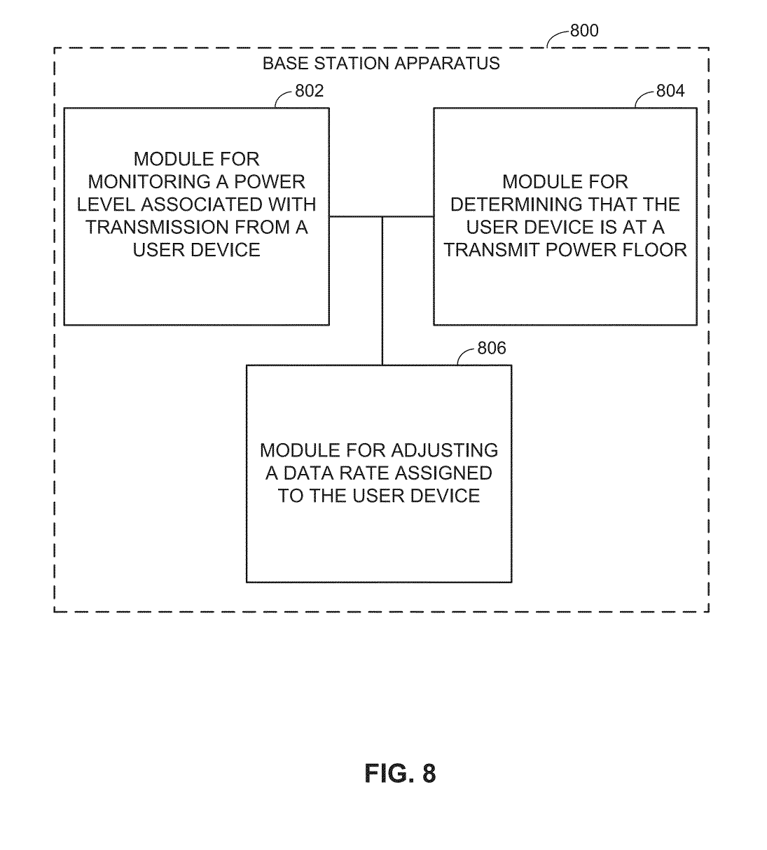

FIG. 8 illustrates an example BS apparatus 800 represented as a series of interrelated functional modules. A module for monitoring a power level associated with a transmission from a UD 802 may correspond at least in some aspects to, for example, a communication device 714, particularly a receiver 718, in conjunction with a processing system 734 and/or a memory component 740, as discussed herein. A module for determining that the UD device is at a transmit power floor 804 may correspond at least in some aspects to, for example, a processing system 734 in conjunction with a memory component 740 as discussed herein. A module for adjusting a data rate assigned to the UD 806 may correspond at least in some aspects to, for example, a processing system 734 in conjunction with a communication device 714, particularly a transmitter 716, as discussed herein.

The functionality of the modules of FIG. 8 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 8, as well as other components and functions described herein, may be implemented using any suitable means. Such means also may be implemented, at least in part, using corresponding structure as taught herein. For example, the components described above in conjunction with the “module for” components of FIG. 8 also may correspond to similarly designated “means for” functionality. Thus, in some aspects one or more of such means may be implemented using one or more of processor components, integrated circuits, or other suitable structure as taught herein.

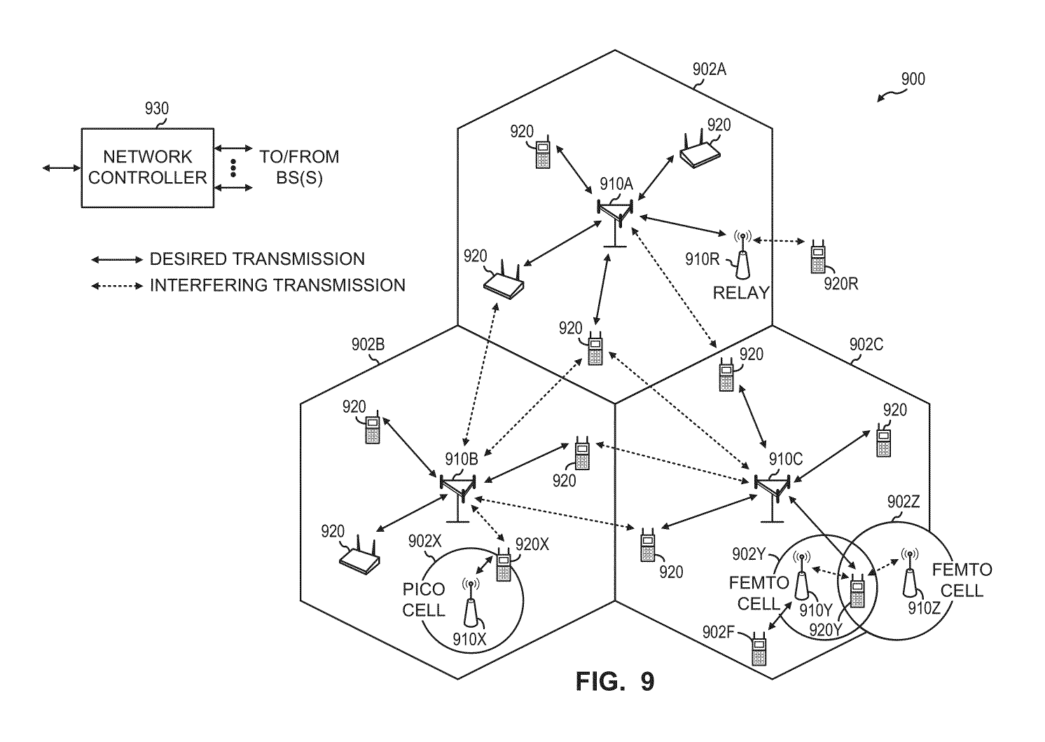

FIG. 9 illustrates an example communication system environment in which the uplink management teachings and structures herein may be may be incorporated. The wireless communication system 900, which will be described at least in part as an LTE network for illustration purposes, includes a number of eNBs 910 and other network entities. Each of the eNBs 910 provides communication coverage for a particular geographic area, such as macro cell or small cell coverage areas.

In the illustrated example, the eNBs 910A, 910B, and 910C are macro cell eNBs for the macro cells 902A, 902B, and 902C, respectively. The macro cells 902A, 902B, and 902C may cover a relatively large geographic area (e.g., several kilometers in radius) and may allow unrestricted access by UEs with service subscription. The eNB 910X is a particular small cell eNB referred to as a pico cell eNB for the pico cell 902X. The pico cell 902X may cover a relatively small geographic area and may allow unrestricted access by UEs with service subscription. The eNBs 910Y and 910Z are particular small cells referred to as femto cell eNBs for the femto cells 902Y and 902Z, respectively. The femto cells 902Y and 902Z may cover a relatively small geographic area (e.g., a home) and may allow unrestricted access by UEs (e.g., when operated in an open access mode) or restricted access by UEs having association with the femto cell (e.g., UEs in a Closed Subscriber Group (CSG), UEs for users in the home, etc.), as discussed in more detail below.

The wireless network 900 also includes a relay station 910R. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs (e.g., a mobile hotspot). In the example shown in FIG. 9, the relay station 910R communicates with the eNB 910A and a UE 920R in order to facilitate communication between the eNB 910A and the UE 920R. A relay station may also be referred to as a relay eNB, a relay, etc.

The wireless network 900 is a heterogeneous network in that it includes eNBs of different types, including macro eNBs, pico eNBs, femto eNBs, relays, etc. As discussed in more detail above, these different types of eNBs may have different transmit power levels, different coverage areas, and different impacts on interference in the wireless network 900. For example, macro eNBs may have a relatively high transmit power level whereas pico eNBs, femto eNBs, and relays may have a lower transmit power level (e.g., by a relative margin, such as a 10 dBm difference or more).

Returning to FIG. 9, the wireless network 900 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. Unless otherwise noted, the techniques described herein may be used for both synchronous and asynchronous operation.

A network controller 930 may couple to a set of eNBs and provide coordination and control for these eNBs. The network controller 930 may communicate with the eNBs 910 via a backhaul. The eNBs 910 may also communicate with one another, e.g., directly or indirectly via a wireless or wireline backhaul.

As shown, the UEs 920 may be dispersed throughout the wireless network 900, and each UE may be stationary or mobile, corresponding to, for example, a cellular phone, a personal digital assistant (PDA), a wireless modem, a wireless communication device, a handheld device, a laptop computer, a cordless phone, a wireless local loop (WLL) station, or other mobile entities. In FIG. 9, a solid line with double arrows indicates desired transmissions between a UE and a serving eNB, which is an eNB designated to serve the UE on the downlink and/or uplink. A dashed line with double arrows indicates potentially interfering transmissions between a UE and an eNB. For example, UE 920Y may be in proximity to femto eNBs 910Y, 910Z. Uplink transmissions from UE 920Y may interfere with femto eNBs 910Y, 910Z. Uplink transmissions from UE 920Y may jam femto eNBs 910Y, 910Z and degrade the quality of reception of other uplink signals to femto eNBs 910Y, 910Z.

Small cell eNBs such as the pico cell eNB 910X and femto eNBs 910Y, 910Z may be configured to support different types of access modes. For example, in an open access mode, a small cell eNB may allow any UE to obtain any type of service via the small cell. In a restricted (or closed) access mode, a small cell may only allow authorized UEs to obtain service via the small cell. For example, a small cell eNB may only allow UEs (e.g., so called home UEs) belonging to a certain subscriber group (e.g., a CSG) to obtain service via the small cell. In a hybrid access mode, alien UEs (e.g., non-home UEs, non-CSG UEs) may be given limited access to the small cell. For example, a macro UE that does not belong to a small cell's CSG may be allowed to access the small cell only if sufficient resources are available for all home UEs currently being served by the small cell.

By way of example, femto eNB 910Y may be an open-access femto eNB with no restricted associations to UEs. The femto eNB 910Z may be a higher transmission power eNB initially deployed to provide coverage to an area. Femto eNB 910Z may be deployed to cover a large service area. Meanwhile, femto eNB 910Y may be a lower transmission power eNB deployed later than femto eNB 910Z to provide coverage for a hotspot area (e.g., a sports arena or stadium) for loading traffic from either or both eNB 910C, eNB 910Z.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method for uplink management.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of enhancing uplink throughput at a small cell base station, comprising:
monitoring a power level associated with one or more user device (UD) transmissions from a UD;
determining whether the UD is at a UD transmit power floor based on the monitored power level; and
in response to determining that the UD is at a UD transmit power floor, adjusting a data rate assigned to the UD.

2. The method of claim 1, wherein monitoring the power level comprises:
receiving the one or more UD transmissions; and
measuring a power level of the one or more received UD transmissions.

3. The method of claim 2, wherein determining that the UD is at the UD transmit power floor comprises:
deriving an expected measured power level for at least one of the UD transmissions, wherein the expected measured power level is based on a transmission power control (TPC) command associated with the at least one of the UD transmissions; and
establishing that a measured power level of the at least one of the UD transmissions exceeds by at least a threshold amount the expected measured power level of the at least one of the UD transmissions.

4. The method of claim 3, wherein the at least one UD transmission comprises two or more UD transmissions, and a measured power level for each of the two or more UD transmissions exceeds an expected measured power level for each of the two or more UD transmissions.

5. The method of claim 2, further comprising:
transmitting a first TPC command associated with a first UD transmit power level; and
transmitting a second TPC command associated with a second UD transmit power level, wherein the second TPC command is transmitted subsequently to the first TPC command, and the second UD transmit power level is less than the first UD transmit power level; wherein:
receiving the one or more UD transmissions comprises receiving a first transmission from the UD associated with the first TPC command and receiving a second transmission from the UD associated with the second TPC command; and
determining that the UD is at the UD transmit power floor comprises establishing that a measured power level of the second transmission is substantially equal to or greater than the measured power level of the first transmission.

6. The method of claim 1, wherein monitoring the power level comprises receiving a headroom indicator associated with the one or more UD transmissions.

7. The method of claim 6, wherein determining that the UD is at the UD transmit power floor comprises:
deriving an expected headroom indicator for at least one of the UD transmissions, wherein the expected headroom indicator is based on a TPC command associated with the at least one of the UD transmissions; and
establishing that the expected headroom indicator exceeds by at least a threshold amount a headroom indicator associated with the at least one of the UD transmissions.

8. The method of claim 6, further comprising:
transmitting a first TPC command associated with a first UD transmit power level; and
transmitting a second TPC command associated with a second UD transmit power level, wherein the second TPC command is transmitted subsequently to the first TPC command, and the second UD transmit power level is less than the first UD transmit power level; wherein:
receiving the one or more UD transmissions comprises receiving a first UD transmission associated with the first TPC command and receiving a second UD transmission associated with the second TPC command; and
determining that the UD is at a UD transmit power floor comprises establishing that a second headroom indicator received from the second UD transmission is substantially equal to or less than a first headroom indicator received from the first UD transmission.

9. The method of claim 1, wherein monitoring the power level comprises logging a set of transmission power control (TPC) command associated with the one or more UD transmissions.

10. The method of claim 1, wherein adjusting the data rate comprises increasing or maintaining the data rate.

11. The method of claim 1, wherein the small cell base station is a UMTS small cell base station and adjusting the data rate comprises transmitting a scheduling grant to the UD.

12. An apparatus for enhancing uplink throughput at a small cell base station, comprising:
a processor operative to:
monitor a power level associated with one or more user device (UD) transmissions from a UD,
determine that the UD is at a UD transmit power floor based on the monitored power level, and
adjust a data rate assigned to the UD based on the determination that the UD is at the UD transmit power floor; and
memory, coupled to the processor, operative to store related data and instructions.

13. The apparatus of claim 12, wherein, to monitor the power level, the processor is operative to:
receive the one or more UD transmissions; and
measure a power level of the one or more received UD transmissions.

14. The apparatus of claim 13, wherein, to determine that the UD is at the UD transmit power floor, the processor is operative to:
derive an expected measured power level for at least one of the UD transmissions, wherein the expected measured power level is based on a transmission power control (TPC) command associated with the at least one of the UD transmissions; and
establish that a measured power level of the at least one of the UD transmissions exceeds by at least a threshold amount the expected measured power level of the at least one of the UD transmissions.

15. The apparatus of claim 14, wherein the at least one UD transmission comprises two or more UD transmissions, and a measured power level for each of the two or more UD transmissions exceeds an expected measured power level for each of the two or more UD transmissions.

16. The apparatus of claim 13, wherein the processor is operative to:
transmit a first TPC command associated with a first UD transmit power level; and
transmit a second TPC command associated with a second UD transmit power level, wherein the second TPC command is transmitted subsequently to the first TPC command, and the second UD transmit power level is less than the first UD transmit power level; wherein:
to receive the one or more UD transmissions, the processor is operative to receive a first transmission from the UD associated with the first TPC command and receive a second transmission from the UD associated with the second TPC command; and
to determine that the UD is at the UD transmit power floor, the processor is operative to establish that a measured power level of the second transmission is substantially equal to or greater than the measured power level of the first transmission.

17. The apparatus of claim 12, wherein, to monitor the power level, the processor is operative to receive a headroom indicator associated with the one or more UD transmissions.

18. The apparatus of claim 17, wherein, to determine that the UD is at the UD transmit power floor, the processor is operative to:
derive an expected headroom indicator for at least one of the UD transmissions, wherein the expected headroom indicator is based on a TPC command associated with the at least one of the UD transmissions; and
establish that the expected headroom indicator exceeds by at least a threshold amount a headroom indicator associated with the at least one of the UD transmissions.

19. The apparatus of claim 17, wherein the processor is operative to:
transmit a first TPC command associated with a first UD transmit power level; and
transmit a second TPC command associated with a second UD transmit power level, wherein the second TPC command is transmitted subsequently to the first TPC command, and the second UD transmit power level is less than the first UD transmit power level; wherein:
to receive the one or more UD transmissions, the processor is operative to receive a first UD transmission associated with the first TPC command and receives a second UD transmission associated with the second TPC command; and
to determine that the UD is at the UD transmit power floor, the processor is operative to establish that a second headroom indicator received from the second UD transmission is substantially equal to or less than a first headroom indicator received from the first UD transmission.

20. The apparatus of claim 12, wherein, to monitor the power level, the processor is operative to log a set of transmission power control (TPC) command associated with the one or more UD transmissions.

21. The apparatus of claim 12, wherein, to adjust the data rate, the processor is operative to increase or maintain the data rate.

22. The apparatus of claim 12, wherein the small cell base station is a UMTS small cell base station and, to adjust the data rate, the processor is operative to transmit a scheduling grant to the UD.

23. An apparatus for enhancing uplink throughput at a small cell base station, comprising:
means for monitoring a power level associated with one or more user device (UD) transmissions from a UD;
means for determining that the UD is at a UD transmit power floor based on the monitored power level; and
means for adjusting a data rate assigned to the UD based on the determination that the UD is at the UD transmit power floor.

24. The apparatus of claim 23, wherein the means for monitoring the power level comprises:
means for receiving the one or more UD transmissions; and
means for measuring a power level of the one or more received UD transmissions.

25. The apparatus of claim 23, wherein the means for monitoring the power level comprises means for receiving a headroom indicator associated with the one or more UD transmissions.

26. The apparatus of claim 23, wherein the means for monitoring the power level comprises means for logging a set of transmission power control (TPC) command associated with the one or more UD transmissions.

27. A non-transitory computer-readable medium storing code, which, when executed by a processor, causes the processor to perform operations for enhancing uplink throughput at a small cell base station, the non-transitory computer-readable medium comprising:
code for monitoring a power level associated with one or more user device (UD) transmissions from a UD;
code for determining that the UD is at a UD transmit power floor based on the monitored power level; and
code for adjusting a data rate assigned to the UD based on the determination that the UD is at the UD transmit power floor.

28. The non-transitory computer-readable medium of claim 27, wherein the code for monitoring the power level comprises:
code for receiving the one or more UD transmissions; and
code for measuring a power level of the one or more received UD transmissions.

29. The non-transitory computer-readable medium of claim 27, wherein the code for monitoring the power level comprises code for receiving a headroom indicator associated with the one or more UD transmissions.

30. The non-transitory computer-readable medium of claim 27, wherein the code for monitoring the power level comprises code for logging a set of transmission power control (TPC) command associated with the one or more UD transmissions.
